(19) United States
(12) Patent Application Publication
(10) Pub. No.: US 2023/0379849 A1
(43) Pub. Date: Nov. 23, 2023

(54) CONVEYANCE OF COMMUNICATIONS IN A WIRELESS NETWORK

(71) Applicant: Charter Communications Operating, LLC, St. Louis, MO (US)

(72) Inventors: Saran Khalid, Denver, CO (US); Perwaiz Akhtar, Aurora, CO (US); Mohammedyusuf M. Shaikh, Denver, CO (US); Mehrab Erfani, Greenwood Village, CO (US)

(21) Appl. No.: 17/747,482

(22) Filed: May 18, 2022

(51) Int. Cl. H04W 56/00; H04B 7/185

(52) U.S. Cl. CPC H04W 56/0015; H04B 7/18513; H04W 56/0065

(57) ABSTRACT

A network environment includes multiple wireless base stations providing wireless access to multiple mobile communication devices. A first wireless base station receives a first signal such as from satellite or other suitable entity. The first signal includes timing information modulated onto a first carrier frequency. The first wireless base station produces a second signal in which the timing information is modulated onto a second carrier frequency. The first wireless base station wirelessly transmits the second signal from the first wireless base station to a second wireless base station in the network environment. The timing information is used by both the first wireless base station and the second wireless base station to synchronization their respective clocks and corresponding wireless communications providing the wireless access to the multiple mobile communication devices.

### BACKGROUND

Conventional RF (Radio Frequency) technology has been used for many years to connect wireless devices such as phones, laptops, etc., to a landline network and other wireless networks. Today, such networks support many different types of connection services such as voice communications, cell communications, high-speed data services, Wi-Fi™ connectivity, and so on.

CBRS (citizens Band Radio System) TD LTE (Long Term Evolution) radios need GPS (Global Positioning System) or Clock Sync signal such as IEEE 1588 for Frequency, Phase and ToD (Time of Day) synchronization A GPS (Global Positioning System) signal is usually available in most places.

However, it is possible that a GPS signal is not available in some cases such as high rise buildings or the GPS may be blocked by a cable, external obstruction, etc.

This disclosure provides an alternative to reliance on receiving a GPS signal directly from a satellite.

### BRIEF DESCRIPTION OF EMBODIMENTS

Embodiments herein provide improved implementation of wireless access networks and expanded use of timing information in a network environment. For example, this disclosure provides an alternative to user equipment relying on direct receipt of GPS signals from a satellite to support synchronization. For example, in certain instances, a communication device (wireless station) may be unable to directly receive a GPS signal from one or more satellites such as when small cells are installed under so-called clutter, i.e., below tree line, buildings, etc. This disclosure assumes presence of other neighbor small cells, with GPS reception capability, and forwarding of synchronization information (a.k.a., timing information) from a first wireless station to one or more wireless stations that cannot directly receive GPS signaling from the one or more satellites.

More specifically, a wireless network environment as discussed herein includes a first wireless base station and one or more other wireless base stations. The first wireless base station (and/or corresponding communication management resource) receives a first signal including timing information modulated onto a first carrier frequency. The first wireless base station produces a second signal in which the timing information is modulated onto a second carrier frequency. The first wireless base station wirelessly transmits the second signal from the first wireless base station to a second wireless base station in the network environment. In one embodiment, the timing information is indicative of or associated with the current time setting of a clock in a satellite.

Further embodiments herein include, via a communication management resource associated with or in the first wireless base station, controlling operation of a switch to convey the first signal to a frequency shifter that produces the second signal.

In still further example embodiments, the first wireless base station receives the first signal on first antenna hardware of the first wireless base station; the first wireless base station transmits the second wireless signal from second antenna hardware of the first wireless base station. In one embodiment, the second antenna hardware of the first wireless base station supports wireless connectivity with the second wireless base station and one or more mobile communication devices provided access to a remote network.

Note that the first signal can be received by the first wireless base station from any suitable resources. For example, in one embodiment, the first signal is a wireless signal communicated from a satellite orbiting the earth. The wireless signal includes a time of a master clock disposed in or associated with the satellite.

The signal wirelessly transmitted from the first wireless base station and corresponding one or more antennas can be used for any suitable purpose. For example, embodiments herein include, via the second signal wirelessly transmitted from the first wireless base station to the second wireless base station, synchronizing wireless communications from one or more wireless stations such as the first wireless base station, the second wireless base station, etc.

Still further embodiments herein include, via the first wireless base station or other suitable entity, providing notification of the timing information to a communication management resource. A communication management resource (or control management entity) such as associated with the first wireless base station and/or second wireless base station notifies the second wireless base station of a window of time of time in which to receive the wirelessly transmitted second signal from the first wireless base station. Additionally. or alternatively, in one embodiment, the communication management resource notifies the second wireless base station of a time delay between the first wireless base station receiving the first wireless signal and the second wireless base station receiving the wirelessly transmitted second signal. In such an instance, the first wireless base station receives clock setting information directly from the satellite or other entity communicating the first signal. Via the timing information, the first wireless base station sets its internal communication clock to a setting associated with the first signal. Via the timing information and the delay information, the second wireless base station sets its internal communication clock to a substantially same setting as the first wireless base station.

The first signal can be received in any suitable channel or carrier frequency. The second signal can be transmitted over any suitable channel or carrier frequency. In one embodiment, the first wireless base station wirelessly transmits the second signal in a guard band from the first wireless base station to the second wireless base station.

In further example embodiments, the network environment as discussed herein includes a third wireless base station. In one embodiment, the second wireless base station produces a third signal in which the timing information is modulated onto a third carrier frequency and wirelessly transmitted from the second wireless base station to the third wireless base station in the network environment. Embodiments herein can further include communicating the second delay information indicating a delay time between the second wireless base station receiving the second signal and the third wireless base station receiving the third signal. Via the timing information associated with the third signal and the second delay information, the third wireless base station sets its internal communication clock to a substantially same setting as the first wireless base station and the second wireless base station and the master clock of the first wireless base station.

Yet further embodiments herein include receiving a decryption key at the first wireless base station. The first wireless base station or other suitable entity decrypts the first signal at the first wireless base station to retrieve the timing information encoded in the first signal from the satellite. The first signal is broadcasted from a satellite or other suitable entity to a third wireless station as well. The first wireless base station is disposed in a vicinity of the third wireless station such that both the first wireless base station and the third wireless base station receive the first signal from the satellite.

In one embodiment, the wireless base station receives schedule information from a management entity. The schedule information indicates a time range or timeslots in which to monitor for presence of the first signal from the satellite. The first wireless base station monitors for the first signal in the time range as specified by the schedule information.

In further example embodiments, the first signal is received by the first wireless base station in a first wireless channel; the first wireless base station communicates the second signal over a second wireless channel to the second wireless base station.

The first wireless channel and the second wireless channel can be allocated from any suitable bandwidth. In one embodiment, one or both of the first wireless channel and the second wireless channel are allocated from a CBRS (Citizen Band Radio Service) bandwidth. In still further example embodiments, the first wireless base station is located in an exclusion zone in which the first wireless base station is not allowed to transmit over the first wireless channel. The second wireless base station is located outside the exclusion zone.

In still further example embodiments, the first signal and the second signal are transmitted in a bandwidth of multiple channels shared by a hierarchy of different users. In one embodiment, the first signal is transmitted by a first tier user in the hierarchy; the first wireless base station is a second tier user of the hierarchy. The first tier user is higher in the hierarchy than the second tier user.

Embodiments herein are useful over conventional techniques. For example, implementation of a repeater/retransmit functionality in a wireless base station enables unique synchronization of multiple wireless stations in network environment.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by the computer processor hardware, cause the computer processor hardware (such as one or more co-located or disparately processor devices or hardware) to: receive a first signal at a first wireless base station in a wireless network environment, the first signal including timing information modulated onto a first carrier frequency; produce a second signal in which the timing information is modulated onto a second carrier frequency; and transmit the second signal from the first wireless base station to a second wireless base station in the network environment.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating implementation of multiple wireless base stations in a network environment according to embodiments herein.

FIG. 2A is an example flow diagram illustrating signal replication and retransmission according to embodiments herein.

FIG. 2B is an example flow diagram illustrating communication of wireless signals over different wireless channels according to embodiments herein.

FIG. 2C is an example diagram illustrating implementation of different timeslots to communicate wireless signals at different times according to embodiments herein.

FIG. 3A is an example diagram illustrating a technique of implementing signal replication and distribution according to embodiments herein.

FIG. 3B is an example diagram illustrating a technique of transmitting and receiving wireless signals according to embodiments herein.

FIG. 4 is an example diagram illustrating management of replicating and distributing timing information according to embodiments herein.

FIG. 5 is an example diagram illustrating frequency shifting according to embodiments herein.

FIG. 6 is an example diagram illustrating implementation of multiple wireless stations and signal retransmission in a network environment according to embodiments herein.

FIG. 7 is an example diagram illustrating signal extraction and distribution in a network environment according to embodiments herein.

FIG. 8 is an example diagram illustrating management of retrieving timing information and subsequent distribution of the timing information according to embodiments herein.

FIG. 9 is an example diagram illustrating example computer hardware and software operable to execute operations according to embodiments herein.

FIG. 10 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DESCRIPTION OF EMBODIMENTS

A network environment includes multiple wireless base stations providing wireless access to multiple mobile communication devices. A first wireless base station receives a first signal such as from a satellite or other suitable wireless entity. The first signal includes timing information modulated onto a first carrier frequency. The first wireless base station produces a second signal in which the timing information is modulated onto a second carrier frequency. The first wireless base station wirelessly transmits the second signal from the first wireless base station to a second wireless base station in the network environment. The timing information is used by both the first wireless base station and the second wireless base station to synchronize their respective master clocks and corresponding wireless communications providing wireless access to the multiple mobile communication devices.

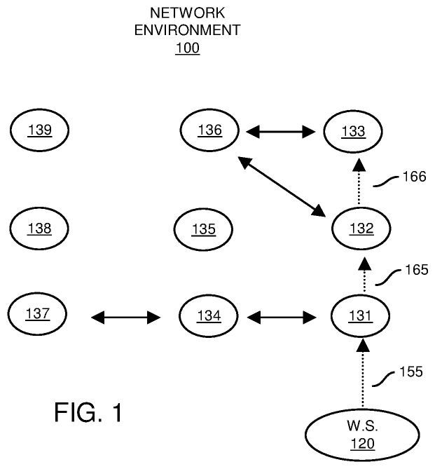

Now, with reference to the drawings, FIG. 1 is an example diagram illustrating implementation of multiple wireless base stations in a network environment according to embodiments herein.

In certain instances, small cells in a network environment are installed in a grid manner. Assume that the cell (i.e., region of wireless coverage) associated with wireless base station 131 receives a GPS signal and the cell associated with wireless base station 132 loses reception of a GPS signal. The loss or reception may be permanent or short term.

If the loss of reception persists, and the wireless base station 132 continues to provide one or more mobile communication devices access to a respective network 190, the wireless base station 132 and corresponding cell will potentially be out of sync with other wireless base stations and stop functioning (i.e., providing network access). In order to avoid losing synchronization with other cells that are able to receive communications from the wireless station 120, the cell and corresponding wireless base station 132 must be periodically synced with one or more other wireless base stations in the network environment 100.

In one embodiment, thus, even though the wireless base station 132 may not be able to receive timing information from a corresponding source (wireless station 120) such as satellite, the wireless base station 131 may be able to receive timing information from the corresponding source (source 120 such as satellite or other suitable entity) and provide such timing information to one or more of the wireless base stations in the network environment 100.

Embodiments herein include reception of a wireless signal 155 by the wireless base station 131. The wireless base station 131 receives the signal 155 from wireless station 120 such as from a satellite 120 or other suitable entity. In one embodiment, the first signal 155 includes timing information modulated onto a first carrier frequency. The first wireless base station 131 produces a second signal 165 in which the timing information is modulated onto a second carrier frequency and communicated to one or more other wireless base stations that are unable to receive wireless station 155.

In further example embodiments, the first wireless base station 131 wirelessly transmits the second wireless signal 165 to a second wireless base station 132 in the network environment 100. The timing information is used by both the first wireless base station 131 and the second wireless base station 132 to synchronize their respective master clocks and corresponding wireless communications providing the wireless access to the multiple mobile communication devices.

Embodiments herein further include reception of a wireless signal 165 by the wireless base station 132. The wireless base station 132 receives the signal 165 from wireless station 131. In one embodiment, the second signal 165 includes timing information modulated onto a second carrier frequency. The second wireless base station 132 produces a third signal 166 in which the timing information is modulated onto a second or third carrier frequency and communicated to one or more other wireless base stations that are unable to receive wireless station 155.

The second wireless base station 132 wirelessly transmits the second wireless signal 166 to a third wireless base station 133 in the network environment 100. The timing information is used by both the first wireless base station 131, the second wireless base station 132, and the third wireless base station 133 to synchronize their respective master clocks and corresponding wireless communications providing the wireless access to the multiple mobile communication devices.

Note that each of the resources as discussed herein can be implemented in any suitable manner. For example, the wireless base station 131, wireless base station 132, etc., (and/or corresponding communication management resource) can be implemented as wireless base station hardware, wireless base station software, or a combination of wireless base station hardware and wireless base station software; and so on.

In one embodiment, each of the wireless base stations (Pal or GAA users) in network environment 100 is a CBSD (Citizen Band Radio Service Device) allocated one or more wireless channels from a CBRS band to provide wireless access to mobile communication devices. The CBRS channels may be revoked at any time if used by a higher priority user.

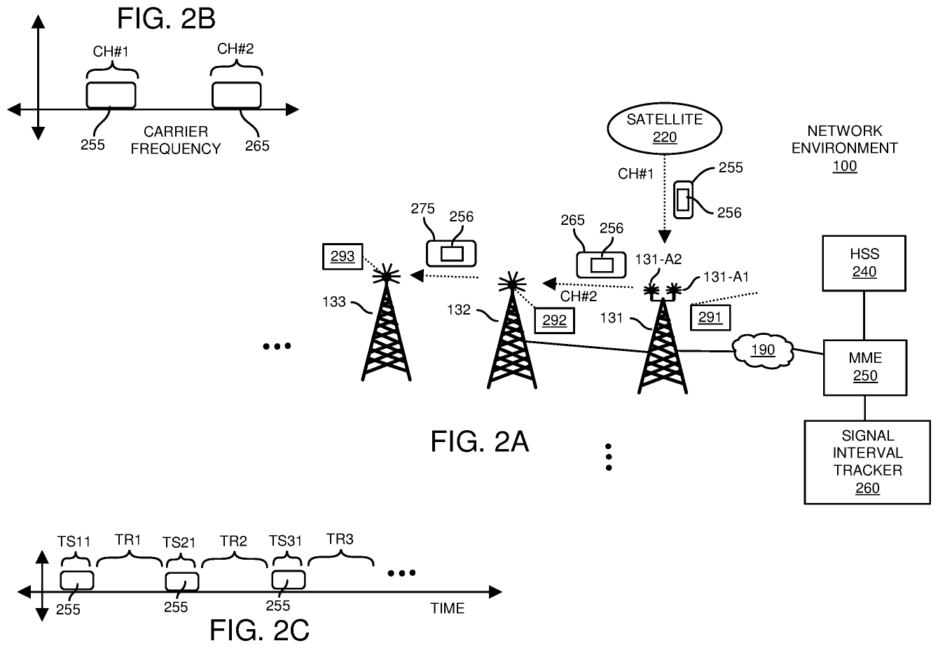

FIG. 2A is an example flow diagram illustrating signal replication according to embodiments herein.

In this example embodiment, the wireless base station 131 provides wireless coverage to a set of one or more mobile communication devices 291 and is able to communicate with the wireless base station 132. Wireless base station 131 provides mobile communication devices 291 wireless access to the network 190.

As further shown, the wireless base station 131 receives wireless signal 255 (such as a GPS signal or timing information used for synchronization of clocks) from the satellite 220 (i.e., a wireless station in orbit of the earth). The wireless base station 131 receives the wireless signal 255 and corresponding timing information 256 (such as timing data encoded in accordance with one or more symbols). In one embodiment, the wireless base station 131 receives the wireless signal 255 (which is encoded to include timing information 256) over channel CH1 via antenna hardware 131-A1.

The wireless base station receiver 131 can be configured to detect the wireless signal 255 in a timeslot (interval of time). In one embodiment, the wireless base station 131 monitors the assigned interval in which the signal 255 is received, i.e., the signal 255 is received on an interval basis and on the order of milliseconds.

In further example embodiments, the interval (timeslot) represents the transmit time of the satellite and the transmission delay, i.e., space transmission delay associated with communicating the wireless station from the satellite 220 to the wireless base station 131.

The MME 250 (such as a communication management resource) can be configured to extract the timing information (data) from the received signal 255 and a processing module calculates the interval and tracks the GPS signal transmission over time. Thus, the MME 250 or other suitable entity can be configured to determine a timing of the satellite 220 periodically communicating the repeated instances of the wireless signal 255 to one or more wireless base stations in the network environment 100.

As further discussed herein, the MME 250 can be configured to communicate the assigned time interval (or timeslots) when instances of the wireless signal 255 are communicated from the satellite 220. For example, the signal interval tracker 260 keeps track of the timeslots in which instances of the wireless signal 255 are communicated from the satellite 220. The tracker 260 or other suitable entity provides notification of the schedule of communicated timing information and wireless signal 255 to the MME 250 such as communication management resource. The MME 250 notifies the second wireless base station 132 of a window of time (timeslot) in which to receive the wirelessly transmitted signal 265 transmitted from the first wireless base station 131.

In yet further example embodiments, the communication management resource (such as MME 250), notifies the second wireless base station 132 of a time delay between the first wireless base station receiving the first wireless signal (such as signal 255) and the second wireless base station 132 receiving the wirelessly transmitted second signal (such as signal 265). In such an instance, although the wireless base stations receive timing information 256 at different times, each of the wireless base station 131 and wireless base station 132 set their respective master clocks to a same setting.

FIG. 2B illustrates communication of the signal 255 and signal 265 in the frequency domain according to embodiments herein. Note that that carrier frequency of wireless channel CH1 can be greater or less than a magnitude of the carrier frequency associated with the wireless channel CH2.

Note that the wireless base station 132 can be configured to communicate the wireless signal 275 via wireless channel CH2 or a different wireless channel CH3.

FIG. 2C illustrates assignment of different timeslots to support communications as discussed herein.

In one embodiment, the wireless base station 131 supports repeater functionality during the timeslots TS11, TS21, TS31, etc.

For example, in timeslot TS11, the wireless base station 131 receives the wireless signal 255 from the satellite 220 in channel CH1 (such as first carrier frequency) over the antenna hardware 131-A1. The wireless base station 131 re-transmits the received wireless signal 255 in timeslot TS11 over channel CH2 (such as second carrier frequency, which is shifted with respect to the for carrier frequency) as wireless signal 265 from antenna hardware 131-A2 in timeslot TS11 to the wireless base station 132. There is a small delay between receiving wireless signal 255 and transmitting wireless signal 265.

Also, in timeslot TS11, the wireless base station 132 (as a repeater wireless station) receives the wireless signal 265 and corresponding timing information 156 from the wireless base station 131 over the antenna hardware 132-A1. The wireless base station 132 re-transmits the received wireless signal 265 in timeslot TS11 as wireless signal 275 (including timing information 155) from antenna hardware 131-A2 in timeslot TS11 to the wireless base station 133.

Thus, the second wireless base station 132 produces a third signal (such as wireless signal 275) in which the timing information 256 (a.k.a., time synchronization information) is modulated onto a third carrier frequency (or the second carrier frequency if the wireless base station 132 is a repeater wireless station) and wirelessly transmits the third signal 275 from the second wireless base station 132 to a third wireless base station 133 in the network environment 100.

In one embodiment, in time range TR1 of FIG. 2C, the wireless base station 131 does not receive the wireless signal 255 from the satellite 220 over antenna hardware 131-A1. In such an instance, during time range TR1, the wireless base station 131 uses the respective antenna hardware 131-A2 to transmit and receive wireless communications to/from a set of one or more mobile communication devices 291 in wireless connectivity with the wireless base station 131 over antenna hardware 131-A2.

Additionally, during time range TR1, the wireless base station 132 uses the respective antenna hardware 132-A to transmit and receive wireless communications to/from a set of one or more mobile communication devices 292 in wireless connectivity with the wireless base station 132 over antenna hardware 132-A.

The communications in time range TR1 can be time-slotted in a time-division manner such that the a first portion of the timeslots associated with time range TR1 support uplink communications from the mobile communication devices to wireless base station 131 and a second portion of the timeslots associated with time range TR1 support downlink communications from the wireless base station 131 to the mobile communication devices. In a similar manner, the communications in time range TR1 can be time-slotted in a time-division manner such that a first portion of the timeslots associated with time range TR1 support uplink communications from a set of mobile communication devices 292 to the wireless base station 132 (via antenna hardware 132-A2) and a second portion of the timeslots associated with time range TR1 support downlink communications from the wireless base station 132 to the mobile communication devices 292.

In timeslot TS21, the wireless base station 131 receives another instance of the wireless signal 255 from the satellite 220 over the antenna hardware 131-A1. The wireless base station 131 re-transmits the received wireless signal 255 in timeslot TS21 as wireless signal 265 from antenna hardware 131-A2 in timeslot TS21 to the wireless base station 132. In timeslot TS21, the wireless base station 132 receives the wireless signal 265 and corresponding timing information 256 from the wireless base station 131 over the antenna hardware 132-A. In a similar manner as previously discussed, the wireless base station 132 can be configured to re-transmit the received wireless signal 265 in timeslot TS21 as wireless signal 275 (including timing information 255) from antenna hardware 131-A in timeslot TS21 to the wireless base station 133.

In time range TR2, the wireless base station 131 does not receive the wireless signal 255 from the satellite 220 over antenna hardware 131-A1. In such an instance, during time range TR2, the wireless base station 131 uses the respective antenna hardware 131-A2 to transmit and receive wireless communications to/from a set of one or more mobile communication devices 291 in wireless connectivity with the wireless base station 131 over antenna hardware 131-A2.

During time range TR2, the wireless base station 132 uses the respective antenna hardware 132-A to transmit and receive wireless communications to/from a set of one or more mobile communication devices 292 in wireless connectivity with the wireless base station 132 over antenna hardware 132-A. As previously discussed, the communications in time range TR2 can be time-slotted in a time-division manner such that the a first portion of the timeslots associated with time range TR2 support uplink communications from the mobile communication devices to wireless base station 131 and a second portion of the timeslots associated with time range TR2 support downlink communications from the wireless base station 131 to the mobile communication devices. In a similar manner, the communications in time range TR2 can be time-slotted in a time-division manner such that the a first portion of the timeslots associated with time range TR2 support uplink communications from a set of mobile communication devices to the wireless base station 132 (via antenna hardware 132-A) and a second portion of the timeslots associated with time range TR2 support downlink communications from the wireless base station 132 to the mobile communication devices.

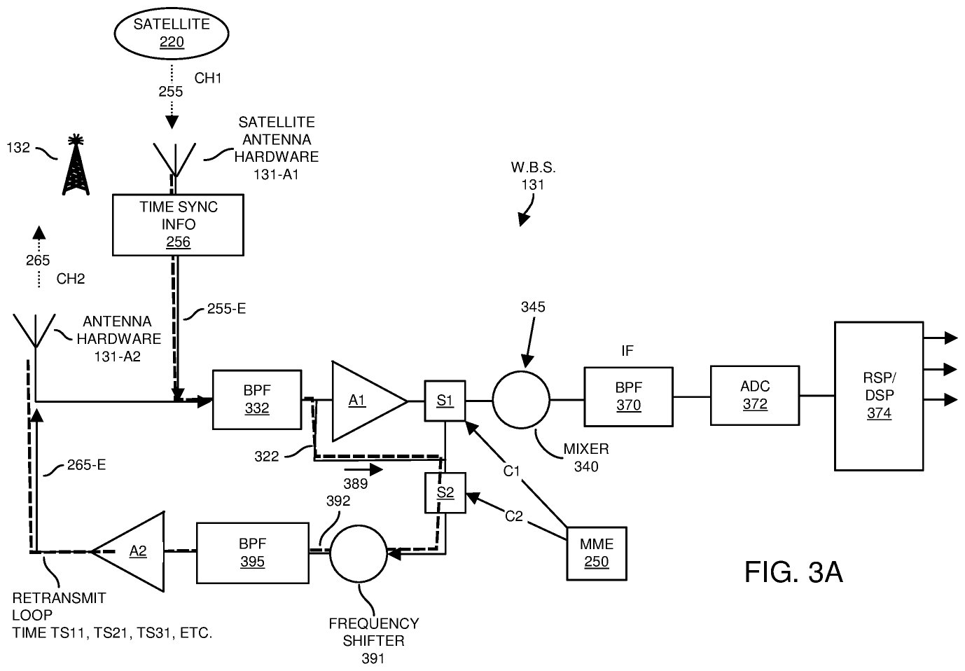

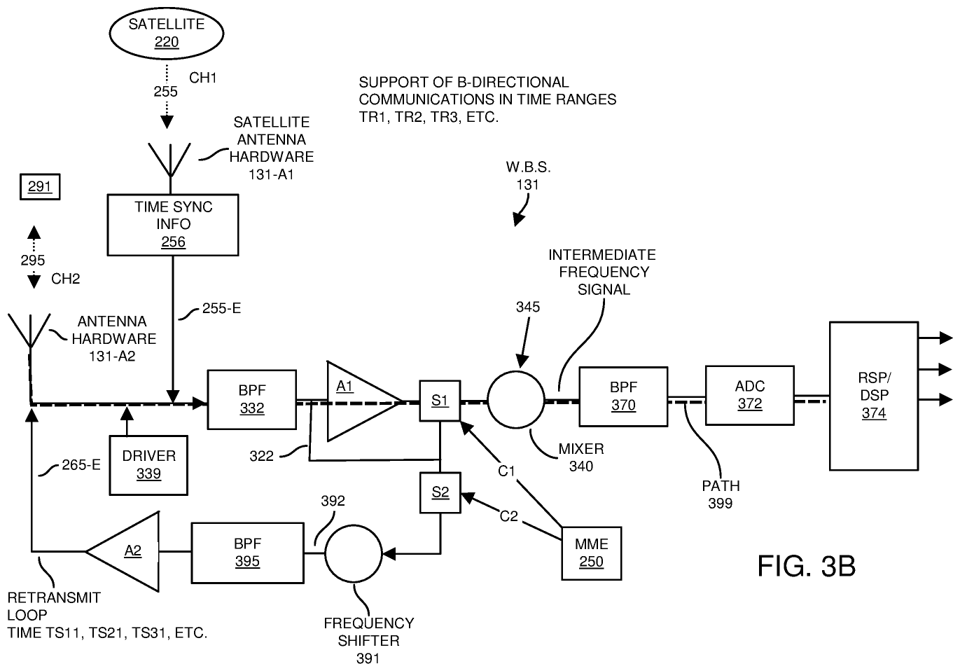

FIG. 3A is an example diagram illustrating a technique of implementing information/signal replication and distribution via a transceiver according to embodiments herein.

In this example embodiment, during each of the timeslots T11, T21, T31, etc., the received wireless signal 255 (such as GPS signal) is circulated via switch S2 to the antenna hardware 131-A2 via control signal C2 provided by a controller such as MME 250.

For example, the wireless signal 255 received on the antenna hardware 131-A1 (such as dedicated to receive GPS signals) is turned into an electrical signal 255-E switched via switch S2 to circuit path frequency shifter 391, band-pass filter 395, and amplifier A2 to generate electrical signal 265-E that launches wireless signal 265 from antenna hardware 131-A2. Thus, embodiments herein include, via the controller (such as MME 250), controlling operation of switch S2 to convey the first signal (255) and corresponding timing information 256 to a frequency shifter 391 that produces the second signal (265) including timing information 256. As further discussed herein, the wireless base station 131 receives the first signal 255 on first antenna hardware 131-A1 of the first wireless base station; the wireless base station 131 transmits the second wireless signal 265 from second antenna hardware 131-A2 of the wireless base station 131.

More specifically, in one embodiment, the MME 250 sends a message (control signals C1 and C2) controlling operation of switches S1 and S2 depending on time intervals calculated by the tracker 260. The intervals (timeslots) of control are shown in FIG. 2C.

Via control provided by the MME 250, the switch S2 is shorted and switch S1 is open when there is transmission of the signal 255 from the satellite 220 to the wireless base station 131 such as in time intervals (or timeslots) T11, T21, T31, etc.

Since the MME 250 can extract the information from the second wireless base station (eNodeB), the wireless base station 131 knows that it is an additional stratum (such as hop in a chain of multiple wireless base stations communicating timing information 256 in the network environment 100) and can add timing adjust corrections, etc., to any of the communications to the wireless base station 132.

Note further that implementation of the amplifier A2 (a.k.a., PA) is optional. In one embodiment, the amplifier A2 is only implemented if the feed (such as signal 389) is received from the BPF 332 (such as over path 322) instead of Linear amplifier A1 (such as LNA). In the former case, it would be needed to increase/decrease (customize) the coverage of the received sync signal (wireless signal 255). In one implementation, an attenuator may be needed to reduce the coverage as well.

Alternatively, as shown, the band-pass filter 332 provides a signal 389 to the amplifier A1. Switch circuitry S1 can be configured to forward the corresponding amplified signal 389 through switch S2 to the frequency shifter 391.

Time synchronized transmission as shown in the timing diagram of FIG. 2C avoids collisions with the satellite signal in a manner as previously discussed. In other words, in one embodiment, when the instance of the wireless signal 255 is received from the satellite 220, the switch S2 is set to a closed (shorted) state. In such an instance, the band-pass filter 332 receives the receives electrical signal 255-E (derived from signal 255) from antenna hardware 131-A1 (i.e., the antenna hardware 131-A2 converts the received wireless signal 255 from the wireless domain to the electrical domain). The band-pass filter 332 conveys the filtered electrical signal 255-E to the switch S2 (shorted state via control signal C2) over path 322. Thus, the bandpass filter 332 forwards the filtered electrical signal 389 (carrier frequency channel CH1) through the switch S2 (in a closed state) to the frequency shifter 391.

As its name suggest, the frequency shifter 391 receives signal 389 and shifts (to a higher or lower magnitude) the carrier frequency associated with the received signal 389 and communicates it as signal 392 to the band-pass filter 395. For example, the frequency shifter 391 produces output 392 (shifted from the first carrier frequency or channel CH1 to the second carrier frequency or channel CH2) provided to the bandpass filter 395 and corresponding amplifier A2. The amplifier A2 generates a respective electrical signal 265-E, which launches wireless signal 265 (over wireless channel CH2) by the antenna hardware 131-A2.

In a similar manner, the wireless base station 132 is configured to receive wireless communications 265 and retransmit each of the multiple instances of the wireless signal 255, 265, etc., as wireless communications 275 during timeslots T11, T21, T31, etc.

FIG. 3B is an example diagram illustrating a technique of transmitting and receiving wireless signals according to embodiments herein.

As shown in FIG. 3B, during time ranges TR1, TR2, TR3, etc., via control signal C2, the controller (such as MME 380) sets the switch S2 to an open state such that any incoming wireless signals 295 at the wireless signal at antenna hardware 131-A2 are communicated over path 399 through a combination of band-pass filter 332, amplifier A2, switch S1 (set to a shorted state), mixer 340, band-pass filter 370, and analog-to-digital converter 372. The processor 374 receives a digital signal derived from the received communications associated with antenna hardware 131-A1 and converts them into appropriate digital data for processing downstream. As previously discussed, such as via driver 339 driving electrical signals to antenna 131-A2 during downlink portions of the time range TR1, the wireless base station 131 can be configured to communicate data in the downlink to the set of mobile communication devices 291.

Thus, as shown in FIGS. 3A and 3B, the switch circuitry S1, S2, etc., provides multiplexing capability in which to forward the received signal 255-E along a respective circuit path including band-pass filter 332, switch S2, frequency shifter 391, band-pass filter 395, and amplifier A2 to produce the wireless signal 265 during timeslots T11, T21, T31, etc. Alternatively, during time range TR1, TR2, TR3, etc., the circuit path (such as including bandpass filter 332, amplifier A1, switch S1, mixer 340, bandpass filter 370, analog-to-digital converter 372, and processing hardware is 374.

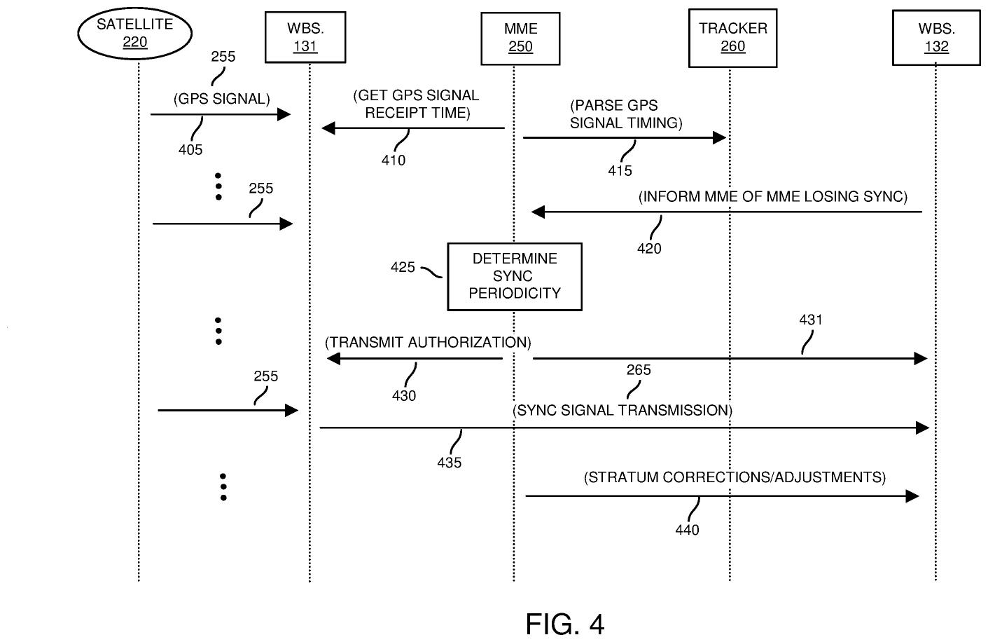

FIG. 4 is an example diagram illustrating management of replication and distribution of corresponding timing information according to embodiments herein.

Via communications 405, the wireless base station 131 receives the wireless signal 255 on antenna hardware 131-A1 in an appropriate timeslot such as TS11, TS21, etc. The wireless base station 131 repeatedly receives instances of the wireless signal 255 over time in assigned timeslots.

In this example embodiment, the wireless base station 131 forwards the communications 410 to the MME 250 (i.e., controller). The MME 250 forwards the received signal and timing information via communications 415 to the tracker 260 for parsing and determination of timeslots in which the wireless base station is to frequency shift and forward any received signal to the wireless base station 132. Thus, the tracker 260 determines timeslots in which each of the wireless base station 131, wireless base station 132, etc., is to retransmit a respective received signal TS11, TS21, TS31, etc.

In one embodiment, the wireless base station 131 can be notified of which wireless base stations in the network environment 100 do not receive the wireless signal 255. In such an instance, those stations that do not or cannot receive the wireless signal 255 can update their respective master time clocks to support synchronized communications in the network environment 100 based on the retransmitted wireless signal 265. For example, to accommodate this condition (inability to receive wireless signal 255), the wireless base station 132 can be configured to transmit communications 420 from the wireless base station 132 to the MME 250. The communications 420 inform the MME 250 that the wireless base station 132 has lost synchronization (such as its respective master timeclock drifts or was never synced) and that the wireless base station 132 is therefore not synchronized or cannot be synchronized via signal 255 to communicate in the wireless network environment 100.

In processing operation 425, the MME 250 determines synchronization periodicity associated with receiving the instances of the wireless signal 255 from the satellite 220. Via subsequent communications 430, the MME 250 transmits the communications 430 to the wireless base stations 131. In one embodiment, the communications 430 include authorization and/or schedule information indicating the different time slots T11, T21, T31, etc., in which the wireless base station 131 is to operate in the repeater/retransmit mode such as when the wireless base station switch S2 is set to a shorted condition such that the received wireless signal 255 over antenna hardware 131-A1 is shifted in frequency and transmitted as wireless signal 265 over antenna hardware 131-A2. In addition to notifying the wireless base station 131 of the different time slots in which the wireless base station is to operate in the repeater/retransmit mode and/or generation of control signals C1, C2, etc., via communications 431, the MME 250 can be configured to notify the wireless base station 132 when the corresponding wireless base station 131 is going to re-transmit the corresponding received wireless signal 255 as wireless signal 265 in the network environment 100.

As previously discussed, the wireless base station 131 repeatedly receives instances of the wireless signal 255 from the satellite 220. Via communications 435, in accordance with schedule information, and/or control of switches, the wireless base station 131 operates in a respective repeater/retransmit mode of retransmitting the received wireless signal 255 as wireless signal 265 including timing information 256 in a manner as previously discussed. Accordingly, the wireless base station 132 receives corresponding timing information 256 from the wireless base station 131 via signal 265.

It is noted that there is a delay between a time of the satellite 220 transmitting the wireless signal 255 and the corresponding time in which the wireless base station 132 receives the wireless signal 265 from the wireless base station 131. To provide correction of this delay (time difference), the MME 350 or other suitable resource determines timing correction information associated with the retransmission communication (265) and includes such information in communications 440 to the wireless base station 132. The wireless base station 130 applies the timing adjustment to the received wireless signal 265 in order to set its corresponding master clock to the same setting as the wireless base station sets its master clock.

In other words, in one embodiment, both the wireless base station 131 and wireless base station 132 set their respective master clock to the same setting (such as clock value) based on receipt of timing information 256. More specifically, the wireless base station 131 sets it master clock to a first value based on receiving the wireless signal 255 and timing information 256. The master clock of the wireless base station 131 increments as the wireless signal 265 is generated and further communicated to the wireless base station 132. At time T2, upon receiving the wireless signal 265 and timing information 256, the wireless base station 132 sets it master clock to the first value plus an adjust delay time associated with processing and communicating the wireless signal 265. Thus, at time T2, the master clock of the wireless base station 131 and the master clock of the wireless base station 132 are set to the same time clock value. In such an instance, the wireless base station 132 and corresponding master clock is synchronized with the wireless base station 131 and corresponding master clock to support wireless communications in the network environment 100.

Note that, in further example embodiments, if so-called stratum adjustments are needed or implemented, the MME 250 will send such a message to the wireless base station 131 (such as enodeB) with one or more attributes as below.

For example, header information om the message includes information similar to a MAC header to identify the receiver to which the message is transmitted. The remaining fields of the stratum message are as follows:
stratum field: indicates the level of stratum: for example, primary secondary etc.
IP version field: IPv4 or IPv6
Status indicator field: clock synchronized or not synchronized
Precision field: precision of the local clock in power of 2.
Root delay field: round trip delay to the primary source
Time stamp field: The time at which the request departed the client for the wireless base station (such as CBSD).
Pathloss delay offset information: this is obtained from (channel state information) CSI information which helps in estimating pathloss and estimate time delay to reach a device

Note further that synch counter information of the message can be decremented (or increment) each time this information is received from another CBSD. For example, a peer to peer establishment of connectivity to share synch information between the primary recipient of synch information i.e., CBSD (wireless base station 131) will decrement (or increment) synch counter before forwarding it to the secondary CBSD (wireless base station 132) and so on so forth. The purpose of doing this is to limit the number of hops as the time sensitive information may actually become inaccurate do to unexpected pathloss delays.

Thus, in an example of incrementing the counter, the message 265 from the wireless base station 131 to the wireless base station 132 may include a counter set to 1 indicating a single hop of retransmitting the wireless signal 265 from the wireless base station 131 to the wireless base station 132. Because the hop value from the wireless base station 131 is set to a value of 1, the wireless base station 132 receiving the wireless signal 265 knows that the wireless signal 265 is a first level transmission of the original wireless signal 255.

As previously discussed, the wireless base station 132 can be configured to re-transmit the received wireless signal 265 as wireless signal 275 (including timing information 256) to the wireless base station 133. The wireless base station 132 receives the counter set equal to 1 and increments this hop count value to a hop count value of 2 when forwarding the wireless signal 275 to the wireless base station 133. Because the hop value from the wireless base station 132 is set to a value of 2, the wireless base station 133 receiving the wireless signal 275 knows that the wireless signal 275 is a second level transmission of the original wireless signal 255.

Note that the # of hops and corresponding forwarded hop counter values (associated with replicated timing information) from one wireless base station to the next in a hierarchy is optional and may only be needed if Sync counter is not available.

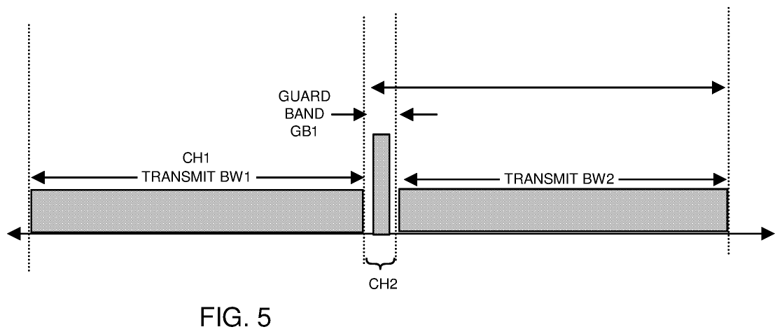

FIG. 5 is an example diagram illustrating frequency shifting according to embodiments herein.

As previously discussed, the wireless base station 131 implements the frequency shifter 391 and related circuitry in path 322 to transmit the corresponding timing information 256 to the wireless base station 132. FIG. 5 shows transmission of the wireless signal 265 in a guard band (such as channel CH2). In one embodiment, the frequency shifting of the original received signal 255 is at a very low power level and in time slots TS11, TS21, TS31, etc., ensures that there is no interference with other devices that might be receiving this information.

In one embodiment, the MME 250 adjusts the BPF 332 and/or band-pass filter 395 of the receiving small cell (wireless base station 132) for each of the respective timeslots T11, T21, T31, etc., (such as a small duration) to ensure the secondary signal (wireless signal 265) is received by wireless base station 132.

In yet further embodiments, the wireless base station 131 receives the wireless signal 255 in the channel CH1 (such as bandwidth BW1). The wireless base station 131 wirelessly transmits the second signal (such as wireless signal 265) in a guard band GB1 from the first wireless base station 131 to the second wireless base station 132. Accordingly, the wireless base station 131 can be configured to communicate the wireless signal 265 in the bandwidth BW2.

In further example embodiments, the satellite 220 transmits data on two frequencies, L1 (1575.42 Mhz) and L2 (1227.60 MHz). The atomic clocks aboard the satellite produces the fundamental L-band frequency, 10.23 Mhz. The L1 and L2 carrier frequencies are generated by multiplying the fundamental frequency by 154 and 120, respectively. The wireless base station 131 can be configured to frequency shift and communicate the wireless signal 265 in the CBRS band such as in a channel of band 3.5 GHz to 3.7 GHz.

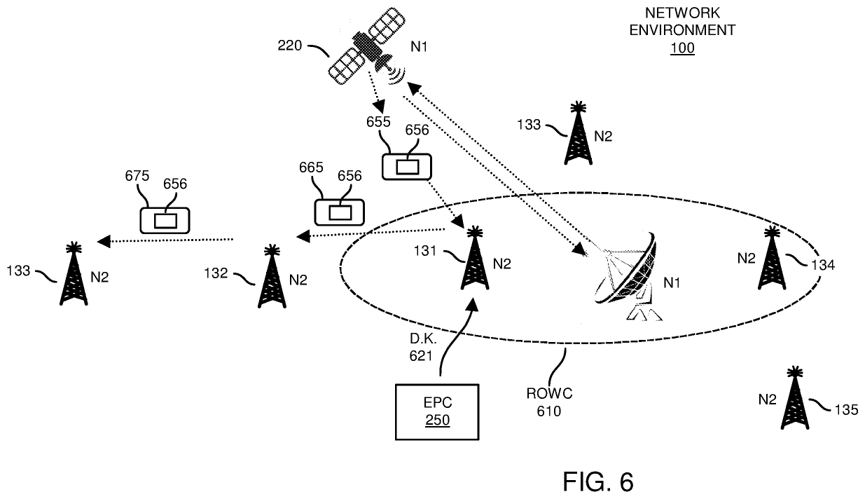

FIG. 6 is an example diagram illustrating implementation of a multiple wireless stations in a network environment according to embodiments herein.

In this embodiment, network N1 includes satellite 220 and wireless station 605. Network N2 includes wireless base station 131, wireless base station 132, wireless base station 133, wireless base station 134, etc. Each of the wireless base stations provides one or more mobile communication devices connectivity to a remote network 190 in a manner as previously discussed.

Satellite 220 (such as a wireless station in orbit about the earth) transmits wireless signal 655 (such as wireless signal 255) to the wireless station 605 (in network N1) such as a dish. The wireless signal 655 is also potentially received by wireless base station 131 (such as on land) in the region of wireless coverage 610 associated with the wireless signal 655.

In one embodiment, the wireless base stations 131, 132, etc., cannot use the wireless band between 3.6 GHz to 3.65 GHz. However, they can listen in that frequency band. The wireless base stations 131 and 134 in the region of wireless coverage 610 are able to receive the wireless signal 655.

In further example embodiments, the wireless signal 655 is encrypted. Wireless station 605 has a decryption key to decrypt the wireless signal 655 and retrieve timing information 656 encoded in the wireless signal 655.

The wireless base stations 131 and 134 receive wireless signal 655 and timing information 656 from the satellite 220, which is an in band communication device (i.e., its receiving it on the same band) for synchronization purpose.

To support synchronization, the core of the small cell network N2 (such as CBRS network) connects with the core of the satellite network N1. The core of the satellite network (such as network N1) provides information to the core of the small cell network N2 (such as wireless base station 131, 132, 133, 134, etc.) such as when to listen to the satellite communication (wireless signal 655) and decrypt such wireless signals 655 with an appropriate decryption key. In other words, the timing information 656 in the wireless signal 655 may be encrypted. Via the decryption key, the wireless base station 131 is able to obtain timing information 656 (such as timing data) encoded in the wireless signal 655.

In a similar manner as previously discussed, the wireless base station 131 decrypts the received wireless signal 655 with the appropriate decryption key 621 and forwards the decrypted (or encrypted) timing information 656 in wireless signal 665 to one or more wireless base stations 132 in a similar manner as previously discussed. Thus, in one embodiment, the timing information 656 is transmitted outwards to other wireless base stations (such as wireless base station 132, wireless base station 133) that do not have the ability to receive and/or decode the wireless signal 655. Thus, the wireless base stations 132, 133, etc., receive timing information 656 via receiving wireless signal 665 via in-band listening.

Via the timing information 656, the wireless base station 132 receiving the retransmitted signal 665 (and decrypted or encrypted timing information 656) synchronizes its master clock to the setting of the master clock associated with the wireless base station 131 (which sets its master clock via received timing information 656).

Thus, if desired, the wireless base station can be configured to receive the decryption key 621 as well. Assume that the wireless base station 131 transmits the wireless signal 665 as an encrypted signal (frequency shifted in a manner as previously discussed). In other words, the wireless base station 131 simply frequency shifts signal 655 to produce an encrypted version of the wireless signal 665. The wireless base station 132 uses the decryption key 621 to obtain the timing information 656 and adjust its master clock in a manner as previously discussed.

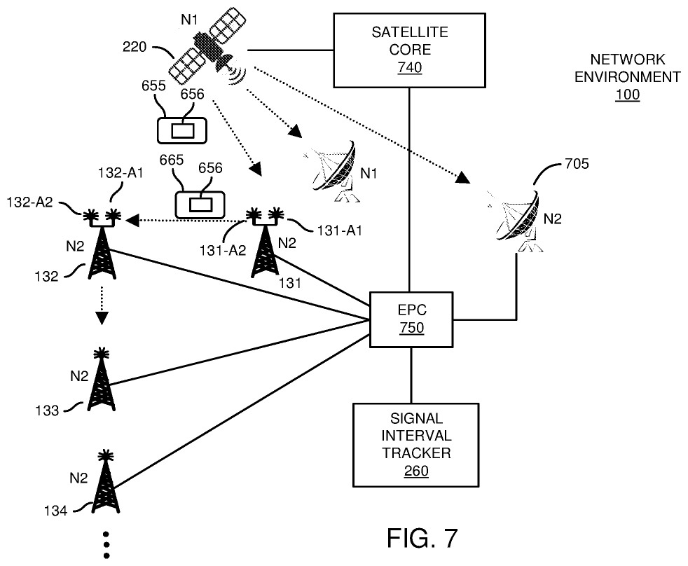

FIG. 7 is an example diagram illustrating signal extraction and distribution according to embodiments herein.

In one example embodiment, the EPC 750 (i.e., communication management resource) of the network N2 receives the decryption key 621 (from network N1) to read particular data (timing information 656 such as time data) as well as the timing information to be read for that particular time slot of receiving the signal 655. In one embodiment, the network environment 100 includes wireless station 705 (such as a dish antenna in network N2) to receive instances of the wireless signal 655 for monitoring and processing. In one embodiment, the EPC 750 (such as communication management resource) associated with the wireless station 705 processes the received instances of the wireless signal 655 to determine timeslots in which the wireless signal 655 is transmitted to set its own master clock supporting wireless communications.

In further example embodiments, an MME or EPC 750 associated with the network N2 instructs the wireless base station 131 (such as CBSDs) to receive instances of the wireless signal 655 and timing information 656 only at certain time intervals (timeslots). In such timeslots, the wireless base station 131 uses the decryption key 621 to process and decrypt the wireless signal 655.

As previously discussed, only certain wireless base stations such as those in the region of wireless coverage 610 may be able to listen to the wireless signal 655 transmitted from the satellite 220.

In further example embodiments, as previously discussed, the wireless base station 131 uses the received wireless signal 655 (received on antenna hardware 131-A1) and corresponding timing information 656 to set its master clock. The wireless base station 131 then retransmits the received wireless signal 655 as wireless signal 665 (and timing information 656) to wireless base station 132 (from antenna hardware 131-A2) such as encrypted or not encrypted. If the timing information is decrypted, this alleviates the wireless base station 132 from having to decrypt the wireless signal 665 and corresponding timing information 656. In a similar manner as previously discussed, note that the wireless base station 131 can be configured to implement frequency shifting to produce the wireless signal 665 and corresponding timing information 656 from wireless signal 655 and timing information 656. See FIG. 2B.

In further example embodiments, the wireless base station 132 uses the received wireless signal 665 (received on antenna hardware 132-A1) and corresponding timing information 656 to set its master clock. The wireless base station 132 then retransmits the received wireless signal wireless signal 675 (and timing information 656) to wireless base station 133 (from antenna hardware 132-A2) such as not encrypted or encrypted. If decrypted, this alleviates the wireless base station 133 from having to decrypt the wireless signal 675 and corresponding timing information 656. In a similar manner as previously discussed, note that the wireless base station 132 can be configured to implement frequency shifting to produce the wireless signal 675 and corresponding timing information 656 from wireless signal 665 and timing information 656. See FIG. 2A.

Since the timing information 656 is transmitted via one or more wireless base station hops, the timing information 656 in the wireless signal 665 is corrected by timing adjustment information taking into account processing and propagation delay associated with converting the received wireless signal 655 into 665 and the wireless base station 132 decoding it to set its master clock.

Note again that hopping and retransmission of the timing information 656 in network and in band listening may be limited to a certain number of wireless base station hops because the quality/accuracy of the timing information 656 will deteriorate each hop.

In further example embodiments, the communication management resource associated with network N2 can be configured to track the wireless base stations by their geographical boundaries to make sure that wireless base station outside a range don't get their sync information via in-network listening by the wireless base station 131. This can be tracked via neighbor relations, i.e., get sync information only via these neighbors and if that's not coming from the neighbor, simply ignore it and use another source.

Note further that the timing information 656 can be heard by the wireless base stations not within the satellite's reach from other CBSD's. They will listen to the MIB transmissions of the in network CBSD. In network base stations will correct this by factors such as processing delay and transmission delay.

Since, the EPC 750 is aware of the distances and by what distance these wireless base stations are apart from each other, the EPC 750 can be configured to help in establishing this propagation delay and providing adjustments.

In one embodiment, the first wireless channel CH1 and/or the second wireless channel CH2 are allocated from a CBRS (Citizen Band Radio Service) bandwidth.

In further example embodiments, the wireless base station 131 is located in an exclusion zone in which the first wireless base station is not allowed to transmit over the first wireless channel on which the wireless signal 655 is transmitted. The second wireless base station 132 is located outside the exclusion zone.

In yet further example embodiments, the first signal 655 and the second signal 665 (or at least the second signal 665) is transmitted in a bandwidth of multiple channels (such as CBRS bandwidth) shared by a hierarchy of different users. The first signal may be transmitted by a first tier user in the hierarchy, the first wireless base station 131 may be being a second tier user in the hierarchy. The first tier user may be higher than the second tier user in the hierarchy.

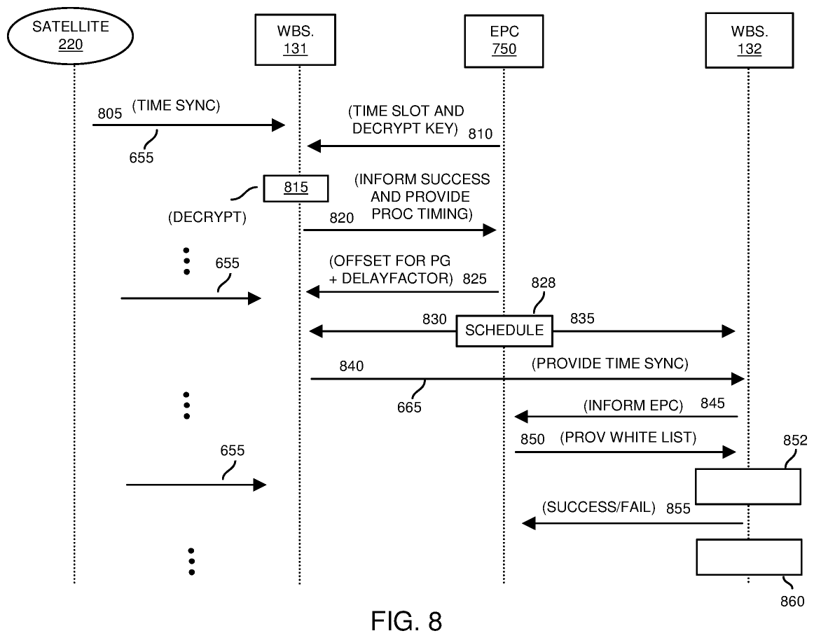

FIG. 8 is an example diagram illustrating management of retrieving timing information and subsequent distribution of the timing information according to embodiments herein.

Via communications 805, the satellite 220 transmits wireless signal 655 to the wireless base station 131. As previously discussed, the satellite 220 repeatedly transmits instances of the wireless signal 655 to the one or more wireless stations in the region of wireless coverage 610.

Via communications 810, the EPC 750 communicates schedule time slot information as well as a corresponding decryption key 621 to be used by the wireless base station 131 to decrypt the instances of the transmitted wireless signal 655.

In processing operation 815, the wireless base station 131 applies the received decryption key 621 to an instance of the received wireless signal 655 to obtain the timing information 656 and set its master clock.

Via communications 820, the wireless base station 131 informs the EPC 750 (communication management resource) of the success of decrypting the received wireless signal 655 and provides process timing information to the EPC 750.

Via communications 825, the EPC 750 communicates offset information for processing and delay factor associated with the wireless base station 131 processing the received wireless signal 655.

In processing operation 820, the EPC 750 generates schedule information indicating when the wireless base station 131 is to retransmit the wireless signal 665 to the wireless base station 132.

Via communications 830, the EPC 750 provides notification of the schedule in which the wireless base station 131 is to communicate the wireless signal 665 to the wireless base station 132. Via communications 835, the EPC 750 notifies the wireless base station 132 of the time in which the wireless base station 132 is to receive the wireless signal 665 from the wireless base station 131.

Via communications 840, the wireless base station 131 transmits the wireless signal 665 and corresponding timing information 656 to the wireless base station 132 in a respective time slot as specified by the schedule information produced by the EPC 750.

Via communications 845, the wireless base station 132 informs the EPC of receiving the wireless signal 665 from the wireless base station 131.

Via communications 850, the EPC 750 provides a white list to the wireless base station 132. The white list indicates that the wireless base station 132 is able to use timing information received from the wireless base station to set its master clock and/or forward the timing information 656 to another wireless base station in the network environment.

In processing operation 852, the wireless base station 132 determines that it is on the white list and therefore able to receive timing information 656 and corresponding wireless communications from the wireless base station 131 and retransmit the received wireless signal 665 and timing information 656 as wireless signal 675 and timing information 656 to another wireless base station in the network environment 100.

Via communications 855, the wireless base station 132 notifies the EPC 750 of a success or failure of receiving the wireless communications.

In processing operation 860, the wireless base station 132 retransmits the wireless signal 665 and corresponding timing information 656 as wireless signal 675 and timing information 656 to wireless base station 133.

In this manner, the base stations support distribution of timing information 656 (a.k.a., timing information 256) to multiple wireless base stations unable to receive wireless signal 655 from the satellite 220.

Note that, in further example embodiments, if so-called stratum adjustments are needed or implemented, an MME or other suitable entity associated with the network N2 will send such a message to the wireless base station 131 (such as enodeB) with one or more attributes as below.

For example, header information in the message from the wireless base station 131 to the wireless base station 132 includes information similar to a MAC header to identify the receiver (wireless base station 132) to which the message is transmitted. The remaining fields of the stratum message are as follows:
stratum field: indicates the level of stratum: for example, primary secondary etc.
IP version field: IPv4 or IPv6
Status indicator field: clock synchronized or not synchronized
Precision field: precision of the local clock in power of 2.
Root delay field: round trip delay to the primary source
Time stamp field: The time at which the request departed the client for the wireless base station (such as CBSD).
Pathloss delay offset information: this is obtained from (channel state information) CSI information which helps in estimating pathloss and estimate time delay to reach a device

Note further that synch counter information of the message can be decremented (or incremented) each time this information is received from another CBSD. For example, a peer to peer establishment of connectivity to share synch information between the primary recipient of synch information, i.e., CBSD (wireless base station 131) will decrement (or increment) synch counter before forwarding it to the secondary CBSD (wireless base station 132) and so on so forth. The purpose of doing this is to limit the number of hops as the time sensitive information may actually become inaccurate do to unexpected pathloss delays.

Thus, in an example of incrementing the counter, the message 665 from the wireless base station 131 to the wireless base station 132 may include a counter set to 1 indicating a single hop of retransmitting the wireless signal 665 from the wireless base station 131 to the wireless base station 132. Because the hop value from the wireless base station 131 is set to a value of 1, the wireless base station 132 receiving the wireless signal 665 knows that the wireless signal 665 is a first level transmission of the original wireless signal 655.

As previously discussed, the wireless base station 132 can be configured to re-transmit the received wireless signal 665 as wireless signal 675 (including timing information 656) to the wireless base station 133. The wireless base station 132 receives the counter set equal to 1 and increments this hop count value to a hop count value of 2 when forwarding the wireless signal 675 to the wireless base station 133. Because the hop value from the wireless base station 132 is set to a value of 2, the wireless base station 133 receiving the wireless signal 675 knows that the wireless signal 675 is a second level transmission of the original wireless signal 655.

Note that the # of hops and corresponding forwarded hop counter values (associated with replicated timing information) from one wireless base station to the next in a hierarchy is optional and may only be needed if Sync counter is not available.

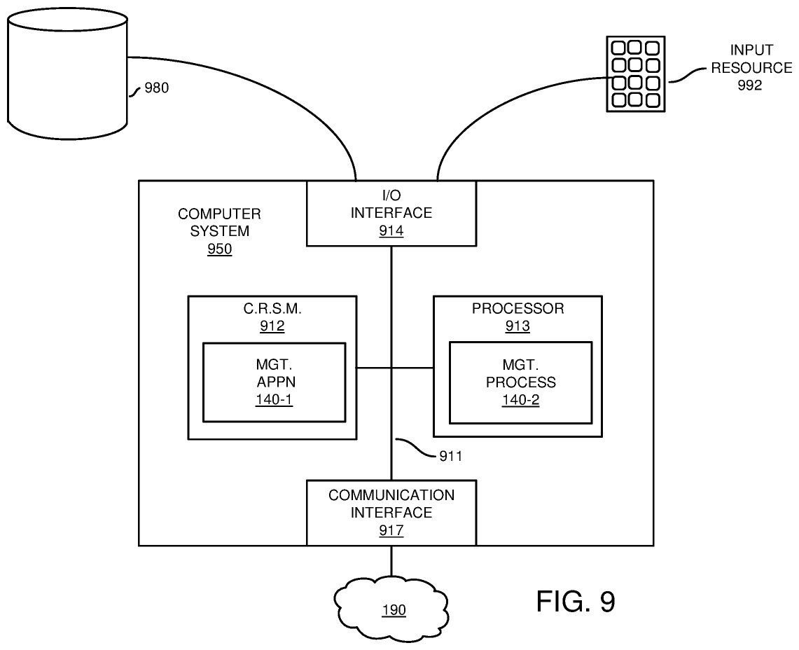

FIG. 9 is an example block diagram of a computer system for implementing any of the operations as previously discussed according to embodiments herein.

Note that any of the resources (such as communication management resource associated with each wireless base station, satellite 220, EPC 750, tracker, etc.) as discussed herein can be configured to include computer processor hardware and/or corresponding executable instructions to carry out the different operations as discussed herein.

For example, as shown, computer system 950 of the present example includes interconnect 911 coupling computer readable storage media 912 such as a non-transitory type of media (which can be any suitable type of hardware storage medium in which digital information can be stored and or retrieved), a processor 913 (computer processor hardware). I/O interface 914, and a communications interface 917.

I/O interface(s) 914 supports connectivity to repository 980 and input resource 992.

Computer readable storage medium 912 can be any hardware storage device such as memory, optical storage, hard drive, floppy disk, etc. In one embodiment, the computer readable storage medium 912 stores instructions and/or data.

As shown, computer readable storage media 912 can be encoded with management application 140-1 (e.g., including instructions) in a respective wireless station to carry out any of the operations as discussed herein.

During operation of one embodiment, processor 913 accesses computer readable storage media 912 via the use of interconnect 911 in order to launch, run, execute, interpret or otherwise perform the instructions in management application 140-1 stored on computer readable storage medium 912. Execution of the management application 140-1 produces management process 140-2 to carry out any of the operations and/or processes as discussed herein.

Those skilled in the art will understand that the computer system 950 can include other processes and/or software and hardware components, such as an operating system that controls allocation and use of hardware resources to execute the management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein.

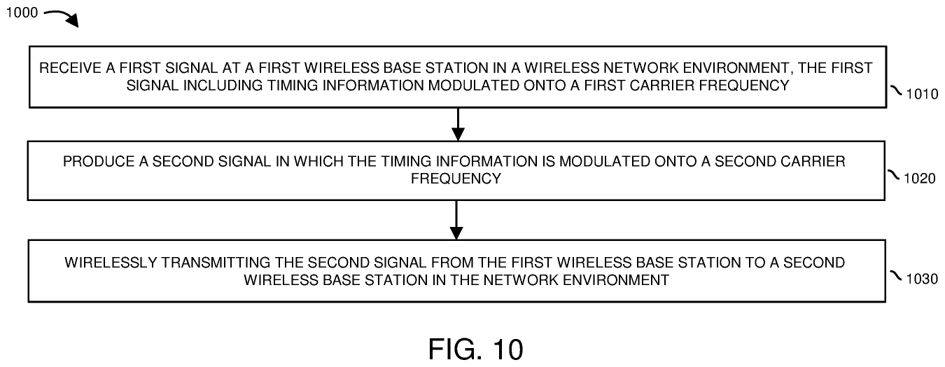

Functionality supported by the different resources will now be discussed via flowcharts in FIG. 10. Note that the steps in the flowcharts below can be executed in any suitable order.

FIG. 10 is a flowchart 1000 illustrating an example method according to embodiments herein. Note that there will be some overlap with respect to concepts as discussed above.

In processing operation 1010, the wireless base station 131 receives a first signal 220. The first signal includes timing information modulated onto a first carrier frequency.

In processing operation 1020, the first wireless base station 131 produces a second signal in which the timing information is modulated onto a second carrier frequency.

In processing operation 1030, the first wireless base station 131 wirelessly transmits the second signal to a second wireless base station 132 in the network environment 100.

Note again that techniques herein are well suited to facilitate processing of available physical infrastructure information and generation of a proposed wireless network installation plan for implementation of the new wireless network. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving a first signal at a first wireless base station in a wireless network environment, the first signal including timing information modulated onto a first carrier frequency;
producing a second signal in which the timing information is modulated onto a second carrier frequency; and
wirelessly transmitting the second signal from the first wireless base station to a second wireless base station in the network environment.

2. The method as in claim 1 further comprising:
controlling operation of a switch to convey the first signal to a frequency shifter that produces the second signal.

3. The method as in claim 1 further comprising:
receiving the first signal on first antenna hardware of the first wireless base station; and
transmitting the second wireless signal from second antenna hardware of the first wireless base station.

4. The method as in claim 3, wherein the second antenna hardware of the first wireless base station supports wireless connectivity with the second wireless base station.

5. The method as in claim 1, wherein the first signal is a wireless signal communicated from a satellite orbiting the earth.

6. The method as in claim 1 further comprising:
via the second signal wirelessly transmitted from the first wireless base station to the second wireless base station, synchronizing wireless communications from the second wireless base station.

7. The method as in claim 1 further comprising:
providing notification of the timing information to a communication management resource; and
via the communication management resource, notifying the second wireless base station of a window of time of time in which to receive the wirelessly transmitted second signal from the first wireless base station.

8. The method as in claim 7 further comprising:
from the communication management resource, notifying the second wireless base station of a time delay between the first wireless base station receiving the first wireless signal and the second wireless base station receiving the wirelessly transmitted second signal.

9. The method as in claim 1 further comprising:
wirelessly transmitting the second signal in a guard band from the first wireless base station to the second wireless base station.

10. The method as in claim 1 further comprising:
at the second wireless base station:
producing a third signal in which the timing information is modulated onto a third carrier frequency; and
wirelessly transmitting the third signal from the second wireless base station to a third wireless base station in the network environment.

11. A system comprising:
a first wireless base station operative to:
receive a first signal at a first wireless base station in a wireless network environment, the first signal including timing information modulated onto a first carrier frequency;
produce a second signal in which the timing information is modulated onto a second carrier frequency; and
wirelessly transmit the second signal from the first wireless base station to a second wireless base station in the network environment.

12. The system as in claim 11, wherein the first wireless base station is further operative to:
control operation of a switch to convey the first signal to a frequency shifter that produces the second signal.

13. The system as in claim 11, wherein the first wireless base station is further operative to:
receive the first signal on first antenna hardware of the first wireless base station; and
transmit the second wireless signal from second antenna hardware of the first wireless base station.

14. The system as in claim 13, wherein the second antenna hardware of the first wireless base station supports wireless connectivity with the second wireless base station.

15. The system as in claim 11, wherein the first signal is a wireless signal communicated from a satellite orbiting the earth.

16. The system as in claim 11, wherein the first wireless base station is further operative to:
via the second signal wirelessly transmitted from the first wireless base station to the second wireless base station, synchronizing wireless communications from the second wireless base station.

17. The system as in claim 11, wherein the first wireless base station is further operative to: provide notification of the timing information to a communication management resource; and
wherein the communication management resource is further operative to notify the second wireless base station of a window of time of time in which to receive the wirelessly transmitted the second signal from the first wireless base station.

18. The system as in claim 17, wherein the communication management resource is further operative to:
notify the second wireless base station of a time delay between the first wireless base station receiving the first wireless signal and the second wireless base station receiving the wirelessly transmitted second signal.

19. The system as in claim 11, wherein the first wireless base station is further operative to:
wirelessly transmit the second signal in a guard band from the first wireless base station to the second wireless base station.

20. The system as in claim 11 further comprising:
a second wireless base station operative to:
produce a third signal in which the timing information is modulated onto a third carrier frequency; and
wirelessly transmit the third signal from the second wireless base station to a third wireless base station in the network environment.

21. Computer-readable storage hardware having instructions stored thereon, the instructions, when carried out by computer processor hardware, cause the computer processor hardware to:
receive a first signal at a first wireless base station in a wireless network environment, the first signal including timing information modulated onto a first carrier frequency;
produce a second signal in which the timing information is modulated onto a second carrier frequency; and
transmit the second signal from the first wireless base station to a second wireless base station in the network environment.

22. The method as in claim 1 further comprising:
receiving a decryption key at the first wireless base station; and
decrypting the first signal at the first wireless base station to retrieve the timing information.

23. The method as in claim 1, wherein the first signal is broadcasted from a satellite to third wireless station; and
wherein the first wireless base station is disposed in a vicinity of the third wireless station.

24. The method as in claim 1 further comprising:
receiving schedule information indicating a time range in which to monitor for presence of the first signal; and
monitoring for the first signal in the time range.

25. The method as in claim 1, wherein the first signal is received by the first wireless base station in a first wireless channel; and
wherein the first wireless base station communicates the second signal over a second wireless channel.

26. The method as in claim 25, wherein the second wireless channel is allocated from a CBRS (Citizen Band Radio Service) bandwidth.

27. The method as in claim 1, wherein the first wireless base station is located in an exclusion zone in which the first wireless base station is not allowed to transmit over the first wireless channel.

28. The method as in claim 27, wherein the second wireless base station is located outside the exclusion zone.

29. The method as in claim 1, wherein the first signal and the second signal are transmitted in a bandwidth of multiple channels shared by a hierarchy of different users, the first signal transmitted by a first tier user in the hierarchy, the first wireless base station being a second tier user of the hierarchy, the first tier user higher than the second tier user in the hierarchy.
